(19) United States
(12) Patent Application Publication
(10) Pub. No.: US 2009/0088519 A1
(43) Pub. Date: Apr. 2, 2009

(54) Furniture polish compositions substantially free of organic solvents

(76) Inventors: Janese Christine O'Brien Stickney, Wyoming, OH (US); Jeffrey Lee Butterbaugh, Cincinnati, OH (US); Steven Baldwin McGowan, Cincinnati, OH (US); Joseph Michael Gaines, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/906,240

(22) Filed: Oct. 1, 2007

(51) Int. Cl. C08L 31/02

(52) U.S. Cl. 524/556

(57) ABSTRACT

An easily spreadable furniture polish composition that provides dusting benefits and imparts shine with minimal residue to a surface to be treated. The furniture polish composition includes a film former, an aqueous carrier, an anionic associative polymer free of acrylates/C10-C30 alkyl acrylate crosspolymers, and is substantially free of organic solvents. In one embodiment, the anionic associative polymer is a hydrophobically-modified alkali-soluble emulsion polymer.

### FIELD OF THE INVENTION

The present invention relates to furniture polishes. More specifically, the present invention relates to furniture polishes substantially free of organic solvents that provide improved spreadability with minimal residue.

### BACKGROUND OF THE INVENTION

Furniture polish compositions are known in the art. Consumers desire easy to spread furniture polishes for dust removal and the shine they impart on surfaces as well as the protective coating they create. There are numerous furniture polishes in the marketplace, such as PLEDGE, which typically contain oil, water, and organic solvents, such as isoparaffins. Such organic solvents provide solvency, spreadability, and stabilization of oils used in traditional furniture polishes. While these organic solvents assist furniture polish compositions in making them easy to apply to a surface, they often require wiping a surface repeatedly to remove dust and buff to a shine. Additionally these organic solvent based furniture polishes leave behind residue or a greasy film on a surface treated with the polish. As such, there remains a need to provide a furniture polish composition which removes dust, is easy to spread and buff to a shine with minimal residue.

### SUMMARY OF THE INVENTION

The present invention is a furniture polish composition that includes about a film former, an aqueous carrier, an anionic associative polymer free of acrylates/C10-C30 alkyl acrylate crosspolymers, and is substantially free of organic solvents. In one embodiment, the anionic associative polymer is a hydrophobically-modified alkali-soluble emulsion (“HASE”) polymer.

The present invention is also directed to a method of improving spreadability and minimizing residue of furniture polish compositions comprising providing a composition comprising a film former, an aqueous carrier, and an anionic associative polymer free of a C10-C30 alkyl acrylate crosspolymer, and substantially free of organic solvents; dispensing said composition on a surface to be treated; and wiping said composition from said surface.

Although the composition is substantially free of organic solvents, it surprisingly provides consumer desired properties of shine, improved spreadability, and minimal residue in comparison to other furniture polishes. Further, the composition of the present invention minimizes the amount of ingredients resulting in greater manufacturing and cost efficiencies.

### DETAILED DESCRIPTION OF THE INVENTION

The present invention is directed to the composition and method described above. “Substantially free of organic solvents” means having no more than about 0.1% by weight of the composition of organic solvents. The furniture polish composition of the present invention provides wet dusting benefits while imparting shine with minimal residue to a surface to which it is applied. The furniture polish provides good spreadability which makes it easy to use in that it does not require excessive effort to hand dust and buff a surface to be treated to a shine. Without wishing to be bound by theory, the spreadability of a furniture polish is believed to be affected by the particle size distribution, flow area, and the coefficient of friction of the composition. The furniture polish composition has a viscosity of about 25 Pas at shear rates less than 1 inverse second and shear thin under increasing shear rates to about 10 Pas at a shear rate of 1 inverse second, and 0.5 Pas at a shear rate of 30 inverse seconds as measured by standard rheology techniques.

### Film Former

The furniture polish composition of the present invention contains a film former to enhance shine of a treated surface. Suitable film formers are those that are conventionally employed in oil and water furniture polishes such as mineral oil and silicone oil. An exemplary film former may be a single type of oil or it may be a mixture of oils. The total film former content may be a mixture of different viscosity silicone oils, for example, a blend of silicone oils having a viscosity from 5 centistokes (cSt) to 30,000 cSt. Suitable silicone oils include, but are not limited to polydimethylsiloxane, such as Dow Corning 200 Solution (20 cst and 10,000 cst), Wacker EF 139409, Wacker F 1079, GE SF96 Series, and Elastomer 6N.

An effective amount of film former is utilized to impart shine to a treated surface. Effective amounts of film former may be an amount from about 0.5% to about 9%, alternatively about 0.8% to about 8% by weight, alternatively about 1% to about 7%, alternatively about 3% to about 7%, alternatively about 5% to about 6%, alternatively at least about 6%, by weight of the composition.

### Emulsifier

Emulsifiers that are suitable in the present invention are anionic associative polymers. Anionic associative polymers may be chosen from copolymers derived from (i) at least one monomer comprising at least one ester derived from a carboxylic acid and a polyethylene glycol ether and (ii) at least one monomer comprising at least one carboxylic acid group. The at least one monomer comprising at least one carboxylic acid group, in one embodiment, may be chosen from acrylic acid and methacrylic acid. The anionic associative polymer may further comprise at least one unit comprising at least one ester chosen from esters derived from acrylic acid and a polyethylene glycol ether and esters derived from methacrylic acid and a polyethylene glycol ether. The polyethylene glycol ether, for example, may be chosen from polyethylene glycol ethers of at least one alcohol chosen from stearyl alcohol, lauryl alcohol, nondecanol, arachidyl alcohol, heneicosanol, behenyl alcohol, tricosanol, triacontanol, and hentriacontanol.

Anionic associative polymers of the present invention may include, but are not limited to, acrylic polymers, such as polyacrylates and polymethacrylates, and acrylic copolymers and crosspolymers, and sodium polyacrylate sold under tradename RAPITHIX™ A-100 from International Specialty Products; alkali-soluble/swellable emulsion (ASE) polymers, hydrophobically-modified alkali-soluble emulsion (HASE) polymers, and hydrophobically-modified ethoxylated urethane (HEUR) polymers, such as those sold under tradename ACULYN™ from Rohm and Haas Company and STRUCTURE® from National Starch and Chemical Company; hydrophobically-modified ethoxylate urethane alkali-soluble/swellable emulsion (HUERASE) polymers, such a those sold under tradename UCAR® POLYPHOBE® from Union Carbide Corporation; copolymers of methyl vinyl ether and maleic anhydride, such as PVM/MA decadiene crosspolymer sold under tradename STABILEEZE® from International Specialty Products); hydrophobically modified non-ionic associative thickeners such as those sold under tradename PURE-THIX® from Sud-Chemie; and mixtures thereof.

In one embodiment, the emulsifiers for the present invention includes a HASE polymer. HASE polymers are typically utilized for increasing the viscosity of aqueous solutions. A HASE polymer typically is a copolymer which contains an anionic group, a hydrophobic group, and a nonionic group. HASE polymers are typically provided as aqueous latex dispersions at low pH with low viscosities. Any conventional surfactants, such as polysorbate 20, can be included in the dispersion to stabilize the HASE polymer. End users neutralize the low pH HASE polymer with a concentrated base such as sodium hydroxide or ammonium hydroxide. Non-limiting examples of HASE polymers, which have been surprisingly found suitable in furniture polish compositions include, but are not limited to, polymeric thickeners sold under the trade names, SALCARE® SC 80 by Ciba Specialty Chemicals Corp.; STRUCTURE® 2001 and STRUCTURE® 3001, by National Starch and Chemical Company; SYNTHALEN® W2000 and STABELYN 30, by 3V Inc., and Acrylates/Steareth-20 Methacrylate Copolymer, which is sold by Rohm & Haas under the name ACULYN® 22; and Acrylates/Beheneth-25 Methacrylate Copolymer, which is sold by Rohm & Haas under the name ACULYN® 28.

SALCARE® SC80 is described in U.S. Pat. No. 6,074,439 to De La Mettrie, et al. as a copolymer of about 40 weight percent methacrylic acid (MAA), about 50 weight percent ethyl acrylate (EA) and about 10 weight percent steareth-10 allyl ether (associative monomer). STRUCTURE® 2001 is described by the manufacturer as a copolymer of acrylic acid, acrylate esters, and steareth-20 itaconate (associative monomer). STRUCTURE® 3001 is described by the manufacturer as a copolymer of acrylic acid, acrylate esters and ceteth-20 itaconate (associative monomer). SYNTHALEN® W2000 is described by the manufacturer as a copolymer of acrylates and palmeth-25 acrylate (associative monomer). ACULYN® 22 is described by the manufacturer as a copolymer of an acrylic acid, methacrylic acid, acrylate ester, and steareth-20 methacrylate (associative monomer). ACULYN® 28 is described by the manufacturer as a copolymer of acrylic acid, methacrylic acid, acrylate esters and beheneth-25 methacrylate (associative monomer). In one embodiment, ACULYN® 28 is utilized in compositions of the present invention. In one embodiment, the composition of the present invention is substantially free of acrylates/C10-C30 alkyl acrylate crosspolymers such as PEMULEN®.

The foregoing commercial HASE polymers have the physical properties shown in Table 1:

TABLE 1

| | Acid | Wt. % | % Total | | |
|---|---|---|---|---|---|
| Polymer | Value | Acid | Solids | pH | Tg |
| SALCARE ® | 242 | 37^{†} (40^{‡}) | 30 | 3 | 60.7 |
| SC 80 | | | | | |
| STRUCTURE ® | 324 | 42^{††} | 28-30 | 2.2-3.5 | 114.7 |
| 3001 | | | | | |
| STRUCTURE ® | 285 | 37^{††} | 28-30 | 2.2-3.5 | 68.7 |
| 2001 | | | | | |
| SYNTHALEN ® | 301 | 46^{†} (39^{††}) | 30-32 | 2-3 | 83.6 |
| W2000 | | | | | |
| ACULYN ® 22 | 267 | 41^{†} (34^{††}) | 29-31 | 2.5-3.5 | 74.4 |
| ACULYN ® 28 | 257 | 40^{†} (33^{††}) | 19-21 | 2.5-3.5 | 55.4 |

Effective amounts of HASE polymer achieve a stable oil and water furniture polish composition in which silicone oils and/or essential oils can be emulsified. Effective amounts can be from about 0.05% to about 4%, alternatively from about 0.05% to about 3%, alternatively from about 0.05% to about 1%, alternatively from about 0.2% to about 1%; alternatively from about 0.2% to about 0.8%, alternatively from about 0.3% to about 0.8%, by weight of the composition.

### Aqueous Carrier

An aqueous carrier is used in the present invention. The aqueous carrier can be distilled, deionized, or tap water. Effective amounts of aqueous carrier in compositions of the present invention include about 88% to about 98%, alternatively about 89% to about 94%; alternatively about 90% to about 92%, by weight of the composition.

### Optional Ingredients

In one embodiment of the present invention, waxes may be added to impart moisture and protection of treated surface. Suitable waxes include, but are not limited to, synthetic and naturally derived nonionics waxes such as parafin wax, beeswax, lanolin wax, shellac wax (animal waxes); camauba, candelilla, bayberry (vegetable waxes); ozokerite, ceresin (mineral waxes); paraffin, microcrystalline waxes (petroleum waxes); polyethylene (ethylenic polymers) and polyethylene homopolymers (Fischer-Tropsch waxes); C30-45 alkyl methicones/dimethicones from Dow Corning and General Electric, KP-560P series of acrylic silicone copolymers from Shin-Etsu Silicones (silicone waxes); and mixtures thereof. Other waxes useful in the present invention are selected from the group consisting of jojoba esters such as the FLORAESTERS® sold by Floratech Americas, PERFORMALENE™ polyethylenes and PERFORMA V™ synthetic polymers sold by New Phase Technologies, alkylated polyvinylpyrrolidines sold under tradename GANEX® from International Specialty Products, SYNCROWAXES® sold by Croda, fatty alcohols from C22 to C50, and mixtures thereof. Synthetic waxes include those disclosed in Warth, Chemistry and Technology of Waxes, Part 2, 1956, Reinhold Publishing. The waxes useful herein are selected from the C₈ to C₅₀ hydrocarbon waxes. Such waxes include long chained polymers of ethylene oxide combined with a dihydric alcohol, namely polyoxyethylene glycol. Such waxes include CARBOWAX™ available from Carbide and Carbon Chemicals Company. Other synthetic waxes include long-chained polymers of ethylene with OH or other stop length grouping at end of chain. Such waxes include the Fischer-Tropsch waxes as disclosed in the text disclosed above at pages 465-469 and include ROSSWAX™ from Ross company and PT-0602 from Astor Wax Company.

In another embodiment of the present invention, beeswax may be used and is usually a mixture of myricyl palmitate, cerotic acid and esters, and some paraffins. A suitable beeswax is Bee's Milk available from Koster Keunen (Wax #138b). The amount of beeswax, when present, in the polish composition is at least about 0.05%, alternatively at least about 0.1%, alternatively about 0.2%, by weight of the composition. Alternatively, the amount of beeswax, when present, in the polish may be from about 0.2% to about 1%, alternatively about 0.2% to about 0.7%, alternatively about 0.2% to about 0.5%, by weight of the composition.

In yet another embodiment of the present invention, perfumes can be included to impart pleasant fragrance from the composition when dispensed. Suitable perfumes are listed in U.S. Pat. No. 6,248,135, which is incorporated in its entirety by reference. In general, a perfume ingredient's character and volatility may be described in terms of its boiling point (or “B.P.”) and its octanol/water partition coefficient (or “P”). The boiling point referred to herein is measured under normal standard pressure of 760 mmHg. The boiling points of many perfume ingredients, at standard 760 mm Hg are given in, e.g., “Perfume and Flavor Chemicals (Aroma Chemicals),” written and published by Steffen Arctander, 1969.

The octanol/water partition coefficient of a perfume ingredient is the ratio between its equilibrium concentrations in octanol and in water. The partition coefficients of the perfume ingredients used in the furniture polish composition may be more conveniently given in the form of their logarithm to the base 10, log P. The log P values of many perfume ingredients have been reported; see for example, the Pomona92 database, available from Daylight Chemical Information Systems, Inc. (Daylight CIS), Irvine, Calif. However, the log P values are most conveniently calculated by the “CLOGP” program, also available from Daylight CIS. This program also lists experimental log P values when they are available in the Pomona92 database. The “calculated log P” (Clog P) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each perfume ingredient, and takes into account the numbers and types of atoms, the atom connectivity, and chemical bonding. The C log P values, which are the most reliable and widely used estimates for this physicochemical property, are preferably used instead of the experimental log P values in the selection of perfume ingredients for the furniture polish composition.

The perfume composition may comprise perfume ingredients selected from one or more groups of ingredients. A first group of ingredients comprises perfume ingredients that have a boiling point of about 250° C. or less and C log P of about 3 or less. A second group of perfume ingredients comprise perfume ingredients that have a boiling point of 250° C. or less and C log P of 3.0 or more. A third group of perfume ingredients comprises perfume ingredients that have a boiling point of 250° C. or more and C log P of 3.0 or less. A fourth group of perfume ingredients comprises perfume ingredients that have a boiling point of 250° C. or more and C log P of 3.0 or more. When present, the compositions of the present invention contain perfumes at levels from about 0.003% to about 5%, alternatively from about 0.05% to about 2%, alternatively from about 0.1% to about 1%, by weight of the composition.

In yet another embodiment of the present invention, essential oils and/or actives of essential oils can be included in the composition of the present invention. Suitable essential oils are those essential oils which exhibit shine and protection on a treated surface. Such essential oils include, but are not limited to, those obtained from almonds, corn, olives, thyme, lemongrass, citrus, lemons, oranges, anise, clove, aniseed, cinnamon, geranium, roses, mint, lavender, citronella, eucalyptus, peppermint, camphor, sandalwood and cedar and mixtures thereof. Actives of essential oils to be used herein include, but are not limited to, thymol (present for example in thyme and may be commercially available for example from Aldrich), eugenol (present for example in cinnamon and clove and may be commercially available for example from Sigma, Systems—Bioindustries (SBI)—Manheimer Inc.), menthol (present for example in mint), geraniol (present for example in geranium and rose), verbenone (present for example in vervain), eucalyptol and pinocarvone (present in eucalyptus), cedrol (present for example in cedar), anethol (present for example in anise), carvacrol, hinokitiol, berberine, terpineol, limonene, and mixtures thereof.

The furniture polish composition of the present invention can contain essential oils in an amount from about 0.005% to about 5%, alternatively from 0.006% to 3%, alternatively from 0.05% to 1%, by weight of the composition.

### Packaging

The furniture polish composition of the present invention can be contained in a non-pressurized form such as a trigger spray dispenser made of any conventional materials including, not limited to polypropylene, polyethylene, polyethylene napthylate, polycarbonate, polyamides, polyethylene terephthalate, polyvinylchloride, and/or polystyrene. The furniture polish composition can also be provided as a wet wipe by methods that are known in the art.

In one embodiment of the present invention, the furniture polish composition is packaged in pressurized form as an aerosol sprayer in an aluminum or plastic can. Suitable propellants include compressible propellants, including but not limited to air, carbon dioxide, nitrogen, nitrous oxide, argon etc. and having the benefit of being inert. Suitable propellants also include condensable propellants, including but not limited to fluorocarbons, hydrocarbons, hydrofluorocarbons, etc. and having the benefit of constant pressure during dispensing. If a condensable propellant is desired, one may apply a vacuum to the volume of the container. This vacuum minimizes the pressure from the condensable propellant, preventing the pressure from becoming too great during a use of the container. If a condensable or compressible propellant is desired, the propellant may be disposed in the container as a solid state of matter, such as a capsule, granules etc. The solid may rupture upon dispensing of material from the container, due to the decrease of the pressure which occurs during dispensing. Additionally or alternatively, the propellant may sublimate to provide the desired pressure in the container. Illustrative propellants include dry ice and acid/base combinations which generate gas. Cryogenic filling of the propellant may be utilized. If cryogenic filling is desired, the bottom of the respective container may be reinforced, as necessary. If desired, the cryogenic propellant may be contained in a cup, for aesthetic purposes.

In one embodiment, the propellant is nitrogen. Without wishing to be bound by any particular theory, when nitrogen is used as the propellant, it is believed that the chemically inert nitrogen does not interact with the perfume ingredients in the furniture polish composition. “Does not interact” means that the nitrogen does not complex with the perfume ingredients such that the hydrophobic and hydrophilic perfume ingredients remain in their respective phases. This results in the fragrances being released at separate times—hydrophilic perfume ingredients releasing first and followed by the release of hydrophobic perfume ingredients. Furthermore, nitrogen has no odor that interferes or alters the intended fragrance of the perfume ingredients. In turn, the present composition provides a longer lasting scent for furniture polish compositions.

Any nozzle or dispensing device can be used to dispense the present composition. For a nozzle having a flow area restriction of 0.016 square millimeters, the best results appear to be obtained at flow area ratios less than 2.5 and from about 3.5 to 4.3. Such results are qualitatively better at relatively lower pressures.

A difference in particle size of approximately 10 microns or less, and particularly approximately 5 microns or less is considered over an operative pressure range is considered to be relatively constant. The foregoing data, which illustrate a relatively constant particle size are shown in Table 2 below. Table 2 shows the upstream flow restriction in square millimeters for various flow area ratios over a pressure range from 8.8-2.3 kg/square centimeters and useable to obtain a particle size difference of approximately 5 microns or less over such pressure range. Table 3 illustrates the same data for a particle size difference ranging from approximately 5-10 microns.

TABLE 2

| Pressure | Flow area | Flow area | Flow area | Flow area |
|---|---|---|---|---|
| range | ratio | ratio | ratio | ratio |
| (Kg/sq cm) | 0.8-1.5 | 1.5-2.5 | 2.5-3.5 | 3.5-4.3/4.4 |
| 8.8-5.6 | 0.006 | 0.006 | | |
| 8.8-5.6 | | 0.010 | 0.010 | 0.010 |
| 5.6-2.3 | | | | 0.016 |

TABLE 3

| Pressure | Flow area | Flow area | Flow area | Flow area |
|---|---|---|---|---|
| range | ratio | ratio | ratio | ratio |
| (Kg/sq cm) | 1.5-2.3 | 2.3-3.0 | 3.0-4.4 | 4.4-7.5 |
| 8.8-5.6 | | | 0.016 | 0.016 |
| 5.6-2.3 | | 0.016 | 0.016 | 0.016 |
| 5.6-2.3 | 0.010 | 0.010 | 0.010 | |

Thus, it appears that for many applications requiring only a 10 micron tolerance, a upstream flow restriction of 0.016, coupled with a flow area ratio of 2.3-7.5 at pressures from 5.6-2.3 kg/square centimeter and ranging from 3.0-7.5 for pressures of 8.8-5.6 kg/sq centimeter is suitable. If a smaller upstream flow restriction of 0.010 square millimeters is selected, this geometry would be usable with a flow area ratio of 1.5-4.4. If the application required a 5 micron tolerance, any of the entries in Table 2 would be suitable.

The mean particle size of the spray droplets dispensed from a container may be in the range of from about 10 μm to about 100 μm, alternatively from about 20 μm to about 60 μm, alternatively from about 50 μm to about 70 μm. Without wishing to be bound to any particular theory, it is believed that the spreadability of the present composition is affected by particle size distribution, flow area, and the coefficient of friction of the composition.

### Method of Use

The furniture polish composition of the present invention can be applied to surfaces that include, but are not limited to, surfaces made of wood, wood laminate, marble, granite, ceramic, porcelain, glass, plastic, stainless steel, leather, and painted surfaces The furniture polish composition can also be applied to a substrate such as a towel, paper towel, or sponge which then contacts a surface to be treated. Once the furniture polish contacts a target surface to be treated, the composition is rubbed on the surface and buffed to a shine.

The following examples are presented for illustrative purposes, and are not intended, in any way, to limit the scope of the invention.

### EXAMPLE 1

In this example, a furniture polish in accordance with the formula in Table 4 is prepared and compared for residue properties against a national brand furniture polish.

TABLE 4

| | | Formula A | Formula B | Formula C |
|---|---|---|---|---|
| | | % by total | % by total | % by total |
| | Ingredient | weight | weight | weight |
| 1 | Deionized water | 91.42 | 91.07 | 90.62 |
| 2 | Aculyn 28 (20%) | 1.00 | 1.00 | 1.00 |
| 3 | Polysorbate BASF | 0.30 | 0.30 | 0.35 |
| | TMAZ-20 | | | |
| 4 | Proxel GXL | 0.08 | 0.08 | 0.08 |
| 5 | Perfume | 0.45 | 0.3 | 0.40 |
| 6 | Silicone Oil (DC 200 | 3.00 | 4.0 | 4.0 |
| | (20 cst)) | | | |
| 7 | Silicone Oil (DC 200 | 3.00 | 2.0 | 2.0 |
| | (10,000 cst)) | | | |
| 9 | BASF SMAZ 20 | 0.30 | 0.30 | 0.35 |
| 10 | Bee's Milk (wax | 0.25 | 0.25 | 0 |
| | #138b) | | | |
| 11 | 5% NaOH solution to | 0.20 | 0.20 | 0.20 |
| | pH 7 | | | |
| 12 | Sweet Almond Oil | 0 | 0.5 | 1.0 |
| | TOTALS: | 100% | 100 | 100 |

ACULYN 28, BASF TMAZ-20, Proxel GXL, and perfume can be added to a 5 gallon mixing vessel. In a separate container DC 200 (20 cst), DC200 (10,000 cst), perfume, and BASF SMAZ 20 are added. The oil phase premix is slowly added to the water phase. The premix vessel is rinsed to remove residual oil phase premix. Bee's milk emulsion is added to the mix. 5% NaOH solution is also added to the mix to reach pH 7.

An alternate method for making the product involves combining water, ACULYN 28, TMAZ 20 and Proxel GXL in a 5 gallon mixing vessel to make the water premix. In a separate container, DC 200 (20 cSt), DC 200 (10,000 cSt), perfume, and BASF SMAZ 20 are added. About 10% of the water premix is added to the oil materials and mixed rapidly for several minutes. The remaining water premix is added and mixing continues. After thoroughly mixed, add bees milk and sodium hydroxide to finish.

To test for the amount of residue left behind by the composition, a blank 4 inch by 4 inch glass tile is weighed and the weight is recorded. The tile is placed on a surface with a cut away having a similar dimension and a recess for receiving the glass tile. The product is sprayed on the tile and the weight is taken immediately and recorded. At 24 hours, the tile is weighed again and the final weight is recorded. A greater difference between the initial weight of the uncoated tile compared to the coated tile indicates that residue has been left behind.

As seen in Tables 5 and 6, the furniture polish of the present invention surprisingly provides less residue than the national brand which contain about 5 to 10% of a hydrocarbon solvent.

TABLE 5

| National | 1 | 2 | 3 | |
|---|---|---|---|---|
| Brand | (grams) | (grams) | (grams) | Averages |
| Blank Tile | 142.5352 | 147.3504 | 146.9195 | |
| Coated Tile | 142.7986 | 147.6396 | 147.2067 | |
| 1440 min | 142.5620 | 147.3759 | 146.9468 | |
| Initial Coat | 0.2634 | 0.2892 | 0.2872 | 0.279933 |
| Final Coat | 0.0268 | 0.0255 | 0.0273 | 0.026533 |
| % residue | 10.2% | 8.8% | 9.5% | 9.5% |

TABLE 6

| Composition | | | | |
|---|---|---|---|---|
| of present | 1 | 2 | 3 | |
| invention | (grams) | (grams) | (grams) | Averages |
| Blank Tile | 145.6623 | 146.6293 | 144.4023 | |
| Coated Tile | 146.3743 | 146.9327 | 144.7713 | |
| 1440 min | 145.7114 | 146.6513 | 144.4282 | |
| Initial Coat | 0.712 | 0.3034 | 0.369 | 0.461467 |
| Final Coat | 0.0491 | 0.0220 | 0.0259 | 0.032333 |
| % residue | 6.9% | 7.3% | 7.0% | 7.1% |

The above Examples demonstrate that the furniture polish composition of the present invention leaves about 36% less residue than the national brand. This is unexpected and surprising given that the composition of the present invention is substantially free of an organic solvent to stabilize the film formers in the composition.

### EXAMPLE 2

In this Example, Formula A is prepared in accordance with the present invention and tested for spreadability along with Formulas B—I which are all national branded furniture polishes that contain organic solvents. Spreadability of a furniture polish is determined by utilizing an Instron® Testing System which uses peak force to calculate static coefficient of friction (“COF”) and average force from sled movement from 3 inches to 9 inches to calculate kinetic COF. A substrate is prepared to fit a sled. A paper towel is cut into a 3 inch by 4 inch piece and folded in a 3 inch by 1 inch strip. The towel is attached to the sled and the weight is recorded. A target surface such as a 150 mm wide by 450 mm long prestained, urethane wood shelf is used. Spray 2 g to 3 g (about 1 to 1.5 seconds of spray) of a furniture polish, from 8 inches away from the shelf, down the middle of the shelf. Start spray on COF beginning side. Weigh exact amount. Place coated shelf into Instron Testing System. Set up sled on shelf and run the Instron System. This process is repeated for each furniture polish desired for testing. The results are shown in Table 4. “Dv (10)” means particle size in microns for 10% of the particles. “Dv (90)” means particle size in microns for 90% of the particles. “Even mist” means Dv(90) minus Dv (10). “Even mist normalized” means the sum of Dv(90) minus Dv(10), divided by 129.69.

TABLE 7

| | Pattern | | | | | | | | | |
|---|---|---|---|---|---|---|---|---|---|---|
| | Diameter | | | % <10 | Static | Kinetic | COF | Even | Even Mist | |
| Formula | (Inches) | Dv(10) | Dv(90) | microns | COF | COF | avg | Mist = Dv(90) − Dv(10) | Normalized | Spread |
| A | 7 | 48.70 | 147.85 | 0.266 | 0.7633 | 0.518 | 0.641 | 99.15 | 0.76452 | 0.702691 |
| B | 8.5 | 66.89 | 170.38 | 2.01 | 0.703 | 0.532 | 0.618 | 103.497 | 0.79803 | 0.707866 |
| C | 7 | 50.18 | 157.25 | 0.472 | 0.906 | 0.418 | 0.662 | 107.078 | 0.82565 | 0.743823 |
| D | 4.5 | 29.47 | 138.63 | 0.99 | 0.872 | 0.634 | 0.753 | 109.16 | 0.8417 | 0.79735 |
| E | 5.5 | 42.14 | 154.92 | 0.6 | 1.056 | 0.424 | 0.74 | 112.78 | 0.86961 | 0.804806 |
| F | 5 | 55.64 | 170.49 | 0.144 | 0.884 | 0.82 | 0.852 | 114.85 | 0.88557 | 0.868787 |
| G | 3 | 57.76 | 179.07 | 0.11 | 0.911 | 0.501 | 0.706 | 121.31 | 0.93538 | 0.820642 |
| H | 5.5 | 53.18 | 179.23 | 0.07 | 0.7588 | 0.614 | 0.686 | 126.05 | 0.97193 | 0.829067 |
| I | 10 | 49.06 | 178.75 | 1.71 | 0.7421 | 0.557 | 0.65 | 129.69 | 1 | 0.824875 |

The results in Table 7 demonstrate that the furniture polish of the present invention is more easily spreadable when compared to furniture polishes that contain organic solvents.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A furniture polish composition having improved spreadability and minimal residue comprising:
a. a film former
b. an aqueous carrier;
c. an anionic associative polymer free of a C10-C30 alkyl acrylate crosspolymers; and
wherein said furniture polish is substantially free of organic solvents.

2. The composition of claim 1 wherein said anionic associative polymer is a HASE polymer.

3. The composition of claim 2 wherein said film former is a silicone oil present in an amount from about 0.5% to about 9%, by weight of said composition.

4. The composition of claim 1 wherein said anionic associative polymer is a beheneth-25 methacrylate copolymer.

5. The composition of claim 1 further comprising a nitrogen propellant.

6. The composition of claim 1 further comprising hydrophobic and hydrophilic perfume materials.

7. The composition of claim 1 wherein said anionic associative polymer is present in an amount from about 0.05% to about 4%, by weight of said composition.

8. The composition of claim 1 wherein said anionic associative polymer is present in an amount from about 0.05% to about 1%, by weight of said composition.

9. The composition of claim 1 wherein said anionic associative polymer is present in an amount from about 0.2% to about 0.8%, by weight of said composition.

10. The composition of claim 1 further comprising a perfume.

11. The composition of claim 1 further comprising about 0.005% to about 5%, by weight of said composition, of an essential oil obtained from a source selected from the group consisting of thyme, lemon grass, lemon, orange, anise, clove, cinnamon, geranium, rose, mint, lavender, eucalyptus, citronella, peppermint, camphor, sandalwood, cedar, and mixtures thereof.

12. A furniture polish composition comprising, by weight:
a. about 0.5% to about 9% silicone oil
b. about 88% to about 98% water; and
c. about 0.05% to about 4% beheneth-25 methacrylate copolymer;
wherein said composition is substantially free of organic solvents.

13. A furniture polish composition suitable for use in a pressurized container comprising:
a. a film former
b. an aqueous carrier; and
C. a HASE polymer; and
d. a nitrogen propellant
wherein said composition is substantially free of organic solvents.

14. A method of improving spreadability and minimizing residue of furniture polish compositions comprising:
a. providing a composition comprising a film former, an aqueous carrier, an anionic associative polymer free of acrylates/C10-C30 alkyl acrylate crosspolymers, and wherein said composition is substantially free of organic solvents;
b. dispensing said composition on a surface to be treated; and
c. wiping said composition from said surface.

15. The method claim 14 wherein said anionic associative polymer is a HASE polymer.

16. The method of claim 15 wherein said HASE polymer is present in an amount from about 0.05% to about 4%, by weight of said composition.

17. The method of claim 14 wherein said anionic associative polymer is acrylates/beheneth-25 methacrylate copolymer.
